(19) United States
(12) Patent Application Publication
(10) Pub. No.: US 2025/0125425 A1
(43) Pub. Date: Apr. 17, 2025

(54) ASSEMBLED BATTERY

(71) Applicant: TOYOTA JIDOSHA KABUSHIKI KAISHA, Toyota-shi (JP)

(72) Inventor: Naotaka TANIMOTO, Nisshin-shi (JP)

(73) Assignee: TOYOTA JIDOSHA KABUSHIKI KAISHA, Toyota-shi (JP)

(21) Appl. No.: 18/767,096

(22) Filed: Jul. 9, 2024

(30) Foreign Application Priority Data
Oct. 16, 2023 (JP) 2023-178521

(51) Int. Cl. H01M 10/0585; H01M 4/02; H01M 4/13

(52) U.S. Cl. CPC H01M 10/0585; H01M 4/13; H01M 2004/021; H01M 2004/027; H01M 2004/028

(57) ABSTRACT

An assembled battery includes a plurality of electrodes each including; a current collector; a negative-electrode composite layer disposed on one surface of the current collector; and a positive-electrode composite layer on the other surface of the current collector, the electrodes being stacked alternately with an electrolyte layer interposed between the electrodes, and a basis weight (mg/cm²) of a negative-electrode composite material or a positive-electrode composite material in the negative-electrode composite layer or the positive-electrode composite layer of each of the electrodes located at upper positions in a stacking direction of the assembled battery is larger than a basis weight (mg/cm²) of a negative-electrode composite material or a positive-electrode composite material in the negative-electrode composite layer or the positive-electrode composite layer of each of the electrodes located at lower positions in the stacking direction of the assembled battery.

### CROSS-REFERENCE TO RELATED APPLICATION

This application claims priority to Japanese Patent Application No. 2023-178521 filed on Oct. 16, 2023, incorporated herein by reference in its entirety.

### BACKGROUND

### 1. Technical Field

The present disclosure relates to an assembled battery.

### 2. Description of Related Art

A lithium-ion secondary battery has been disclosed in which in order to increase the capacity of the battery while minimizing degradation of the charge/discharge rate characteristics, the amount of a positive-electrode active material per unit area of a current collector in each positive electrode located at a position closer to the center in the stacking direction is larger than the amount of a positive-electrode active material per unit area of a current collector in each positive-electrode located at a position farther from the center in the stacking direction (see Japanese Unexamined Patent Application Publication No. 2019-46758).

### SUMMARY

However, in assembled batteries, electrodes located at lower positions in the stacking direction are thinned by the load of electrodes located at upper positions in the stacking direction, which decreases the distance of material movement within the electrodes on the lower side, resulting in decrease in internal resistance and increase in capacity. Hence, in assembled batteries in which cells are connected in series in the stacking direction, there is a risk that at the time of charging, variations in state of charge (SOC) depending on the positions of cells (single cells) in the stacking direction might be caused, and thus variations in degree of degradation of the electrodes might be caused due to overcharging.

A problem to be solved by one embodiment of the present disclosure is to provide an assembled battery that reduces a phenomenon that as the electrodes are located at lower positions (on the gravity side) in the stacking direction of the assembled battery, increase in capacity due to thinning by the load becomes greater, and thus variation in degree of deterioration of the electrodes is caused due to overcharging at the time of charging the assembled battery.

The term “upper position in the stacking direction” means the direction opposite to gravity, and the term “lower position in the stacking direction” means the gravity direction.

The following aspects are included in means for solving the above problems.

<1> An assembled battery including a plurality of electrodes, each of the electrodes including: a current collector; a negative-electrode composite layer disposed on one surface of the current collector; and a positive-electrode composite layer on the other surface of the current collector, the electrodes being stacked alternately with an electrolyte layer interposed between the electrodes, wherein a basis weight (mg/cm²) of a negative-electrode composite material or a positive-electrode composite material in the negative-electrode composite layer or the positive-electrode composite layer of each of the electrodes located at upper positions in a stacking direction of the assembled battery is larger than a basis weight (mg/cm²) of a negative-electrode composite material or a positive-electrode composite material in the negative-electrode composite layer or the positive-electrode composite layer of each of the electrodes located at lower positions in the stacking direction of the assembled battery.

<2> The assembled battery described in <1>, wherein a density (g/cm³) of a negative-electrode active material or a positive-electrode active material of the negative-electrode composite material or the positive-electrode composite material in the negative-electrode composite layer or the positive-electrode composite layer of each of the electrodes located at the upper positions in the stacking direction is larger than a density (g/cm³) of a negative-electrode active material or a positive-electrode active material of the negative-electrode composite material or the positive-electrode composite material in the negative-electrode composite layer or the positive-electrode composite layer of each of the electrodes located at the lower positions in the stacking direction of the assembled battery.

According to the present disclosure, there is provided an assembled battery that reduces a phenomenon that as the electrodes located at lower positions (on the gravity side) in the stacking direction of the assembled battery, increase in capacity due to thinning by the load becomes greater, and thus variation in degree of deterioration of the electrodes is caused due to overcharging at the time of charging the assembled battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing an example of a structure of an assembled battery of the present disclosure;

FIG. 2 is a plot showing a relationship between a ratio of a capacity (mAh/g) of a positive electrode or a negative electrode of a cell (single cell) located at the uppermost position of the assembled battery to a capacity (mAh/g) of a positive electrode or a negative electrode of a cell (single cell) located at the lowermost position of the assembled battery of the present disclosure, and time (days of storage); and

FIG. 3 is a plot showing a relationship between a difference (%) in initial capacity (mAh/g) between a positive electrode or a negative electrode of a cell (single cell) located at the uppermost position of the assembled battery and a positive electrode or a negative electrode of a cell (single cell) located at the lowermost position of the assembled battery of the present disclosure, and the number of years of use (years).

### DETAILED DESCRIPTION OF EMBODIMENTS

Hereinafter, embodiments of the present disclosure will be described. The description is intended to illustrate the embodiments and is not intended to limit the scope of the present disclosure.

In the present specification, a numerical range indicated by using “to” indicates a range including numerical values listed before and after “to” as a minimum value and a maximum value, respectively. In numerical ranges described stepwise in the present embodiment, an upper limit value or a lower limit value described in one numerical range may be replaced by an upper limit value or a lower limit value of another numerical range described stepwise. In the numerical ranges described in the present embodiment, an upper limit value or a lower limit value of a numerical range of interest may be replaced by values shown in the embodiment examples.

In the present specification, the term “process” includes not only an independent process, but also a process even when this process cannot be clearly distinguished from the other processes as far as a desired purpose of this process is achieved.

In the present specification, when the embodiments are described with reference to the drawings, the configurations of the embodiments are not limited to the configurations shown in the drawings. The dimensions of members in each drawing are conceptual, and the relative relationship of the dimensions between the members is not limited to this.

In this specification, each component may contain a plurality of concerned substances. In the present embodiment, in description of the amount of each component in a composition, when a plurality of substances corresponding to each component is present in the composition, the amount means a total amount of the plurality of substances present in the composition, unless otherwise specified.

In the present specification, a “particle size” means a volume-averaged median diameter D₅₀.

### Assembled Battery

An assembled battery of the present disclosure is
an assembled battery that includes a plurality of electrodes, each of the electrodes including: a current collector; a negative-electrode composite layer disposed on one surface of the current collector; and a positive-electrode composite layer on the other surface of the current collector, the electrodes being stacked alternately with an electrolyte layer interposed between the electrodes, and
a basis weight (mg/cm²) of a negative-electrode composite material or a positive-electrode composite material in the negative-electrode composite layer or the positive-electrode composite layer of each of the electrodes located at upper positions in a stacking direction of the assembled battery is larger than a basis weight (mg/cm²) of a negative-electrode composite material or a positive-electrode composite material in the negative-electrode composite layer or the positive-electrode composite layer of each of the electrodes located at lower positions in the stacking direction of the assembled battery.

With the above configuration, it is possible to reduce a phenomenon that as the electrodes located at lower positions (on the gravity side) in the stacking direction of the assembled battery, increase in capacity due to thinning by the load becomes greater, and thus variation in degree of deterioration of the electrodes is caused due to overcharging at the time of charging the assembled battery.

Hereinafter, the assembled battery of the present disclosure will be described with reference to the drawings.

### Assembled Battery

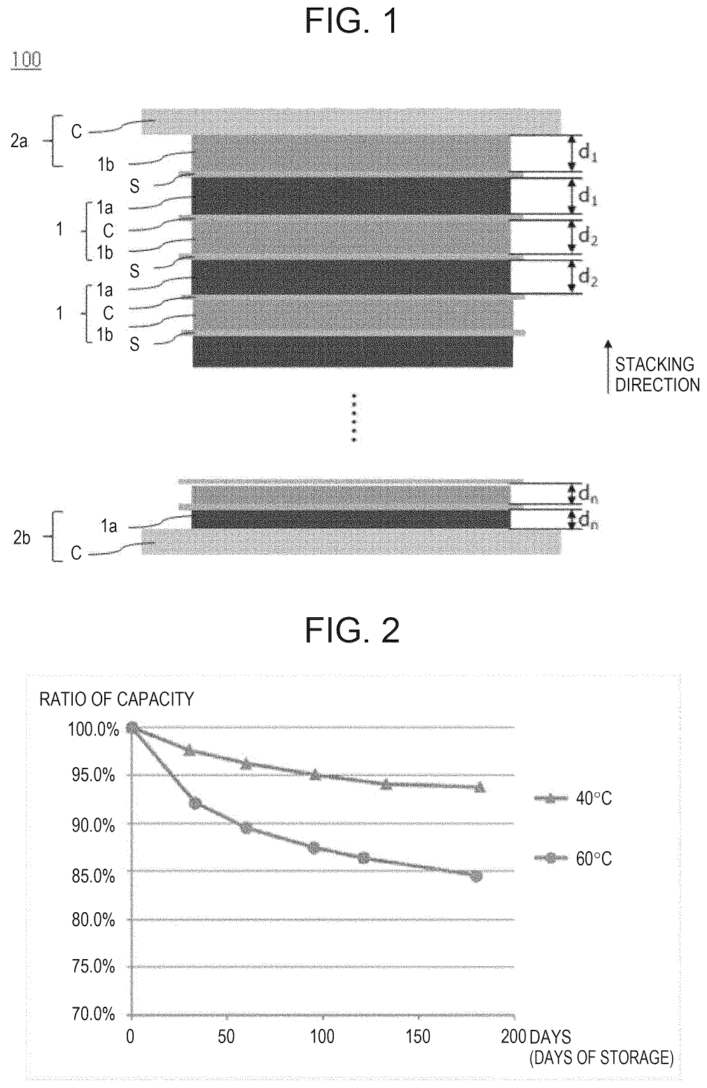

FIG. 1 is a schematic sectional view showing an example of the structure of the assembled battery of the present disclosure. As shown in FIG. 1, an assembled battery 100 includes a plurality of electrodes 1 each including a current collector C, a negative-electrode composite layer 1a disposed on one side of each current collector C and a positive-electrode composite layer 1b disposed on the other side of this current collector C, and the electrodes are stacked alternately with electrolyte layers S interposed therebetween. In the assembled battery 100 of the present disclosure, a basis weight (mg/cm²) of a negative-electrode composite material or a positive-electrode composite material in the negative-electrode composite layer 1a or the positive-electrode composite layer 1b of each of the electrodes 1 located at upper positions in the stacking direction of the assembled battery 100 is larger than a basis weight (mg/cm²) of a negative-electrode composite material or a positive-electrode composite material in the negative-electrode composite layer 1a or the positive-electrode composite layer 1b of each of the electrodes 1 located at lower positions in the stacking direction of the assembled battery 100.

As shown in FIG. 1, the assembled battery 100 of the present disclosure preferably has, at the uppermost position, a positive terminal electrode 2a including the positive-electrode composite layer 1b and the current collector C. In addition, the assembled battery 100 of the present disclosure preferably has, at the lowermost position, a negative terminal electrode 2b including the negative-electrode composite layer 1a and the current collector C.

### Electrodes

Electrodes each include the current collector, the negative-electrode composite layer disposed on one side of the current collector, and the positive-electrode composite layer on the other side of the current collector. The electrode can be easily obtained by coating and drying one of the negative-electrode composite material and the positive-electrode composite material on one side of the current collector, and then coating and drying the other on the other side in the same manner. The electrodes may be pressed and or cut if necessary.

### Current Collector

As examples of the current collector, for example, those formed by metal members such as Cu, Al, Fe, Co, Ni, Cr, Ni-plated steel, or stainless steel may be included. The metal member included in the current collector may be selected from one or more metal members according to the purpose.

The thickness of each current collector is not particularly limited. For example, the thickness may be 0.1 μm to 1,000 μm.

### Negative-Electrode Composite Layer

The negative-electrode composite layer includes a negative-electrode active material, a conductive agent, and a binder.

As examples of the negative-electrode active material, Li-based active materials such as metallic lithium, carbon-based active materials such as graphite, oxide-based active materials such as lithium titanate (e.g., Li₄Ti₅O₁₂), and Si-based active materials such as Si alone, etc., may be included.

The shape of the negative-electrode active material is not particularly limited. For example, the shape may be spherical (e.g., true spherical, ellipsoidal, etc.), fibrous, or the like.

When the shape of the negative-electrode active material is spherical, the particle size of the negative-electrode active material is 0.1 μm to 100 μm, for example.

The specific surface area of the negative-electrode active material is 0.1 m²/g to 1,500 m²/g, for example.

As a negative-electrode conductive agent, carbon materials such as acetylene black, Ketjen black, vapor-phase carbon fiber (VGCF (registered trademark)), and carbon nanotubes (CNT) may be included, for example.

The content of the conductive agent is 3 mass % to 5 mass % of the negative-electrode active material, for example.

As examples of the binder, polyvinylidene fluoride (PVDF)/NMP-based, styrene-butadiene rubber (SBR)/water-based, polytetrafluoroethylene (PTFE)/water-based binders, etc., may be included.

The content of the binder is 3 mass % to 5 mass % of the negative-electrode active material, for example.

### Positive-Electrode Composite Layer

The positive-electrode composite layer includes a positive-electrode active material, a conductive agent, and a binder. As examples of the positive-electrode active material, lithium composite oxides may be included, for example. As examples of the lithium composite oxide, lithium cobaltate, lithium nickelate, lithium manganate, LiNi_{1/3}Co_{1/3}Mn_{1/3}O₂, etc., may be included, for example. The lithium composite oxide may include at least one selected from a group consisting of F, Cl, N, S, Br, and I.

The shape of the positive-electrode active material is not particularly limited. For example, the shape may be spherical (e.g., true spherical, ellipsoidal, etc.), fibrous, or the like.

The particle size of the positive-electrode active material is 0.1 μm to 30 μm, for example.

The specific surface area of the positive-electrode active material is 0.1 m²/g to 100 m²/g, for example.

As the conductive agent, the same as that exemplified in the negative-electrode composite layer can be used.

The content of the conductive agent layer is 3 mass % to 5 mass % of the positive-electrode active material, for example.

As the binder, the same as that exemplified in the positive-electrode composite layer can be used.

The content of the binder is, for example, 3 mass % to 5 mass % of the positive-electrode active material, for example.

In the assembled battery of the present disclosure, the basis weight (mg/cm²) of the negative-electrode composite material or the positive-electrode composite material in the negative-electrode composite layer or the positive-electrode composite layer of each of the electrodes located at upper positions in the stacking direction of the assembled battery is larger than the basis weight (mg/cm²) of the negative-electrode composite material or the positive-electrode composite material in the negative-electrode composite layer or the positive-electrode composite layer of each of the electrodes located at lower positions in the stacking direction of the assembled battery. With this configuration, the electrodes increase in capacity and portions of the electrodes located at upper positions equivalent to a difference in internal resistance from the electrodes located at lower positions are reduced; therefore, the phenomenon can be easily reduced that as the electrodes located at lower positions in the stacking direction of the assembled battery, increase in capacity due to thinning by the load becomes greater, and thus variation in degree of deterioration of the electrodes is caused due to overcharging at the time of charging the assembled battery.

Therefore, it is preferable to perform coating of the negative-electrode composite material or the positive-electrode composite material (hereinafter, simply referred to as “coating” for brevity) such that the basis weight (mg/cm²) of the negative-electrode composite material or the positive-electrode composite material of each of the electrodes located at upper positions in the stacking direction of the assembled battery is larger than the basis weight (mg/cm²) of the negative-electrode composite material or the positive-electrode composite material of each of the electrodes located at lower positions in the stacking direction of the assembled battery.

It is preferable to perform the coating such that the basis weight (mg/cm²) of the negative-electrode composite material or the positive-electrode composite material in the negative-electrode composite layer or the positive-electrode composite layer of the electrode located at the uppermost position of the assembled battery is 10 mg/cm² to 50 mg/cm², for example. It is preferable to perform the coating such that the basis weight (mg/cm²) of the negative-electrode composite material or the positive-electrode composite material in the negative-electrode composite layer or the positive-electrode composite layer of the electrode located at the lowermost position of the assembled battery is 10 mg/cm² to 50 mg/cm², for example.

The coating may be performed such that when the thickness of the assembled battery is 100 mm, the basis weight (mg/cm²) of the negative-electrode composite material or the positive-electrode composite material of the electrode located at the uppermost position of the assembled battery becomes 100.5% to 102% of the basis weight (mg/cm²) of the negative-electrode composite material or the positive-electrode composite material of the electrode located at the lowermost position in the stacking direction of the assembled battery, and may be performed such that the basis weight (mg/cm²) becomes 101%, for example.

The coating may be performed such that when the thickness in the stacking direction of the assembled battery is 200 mm, for example, the basis weight (mg/cm²) of the negative-electrode composite material or the positive-electrode composite material of the electrode located at the uppermost position of the assembled battery becomes 101% to 104% of the basis weight (mg/cm²) of the negative-electrode composite material or the positive-electrode composite material of the electrode located at the lowermost position of the assembled battery, and may be performed such that the basis weight (mg/cm²) becomes 102%, for example.

The basis weight (mg/cm²) can be found as follows.

(1) The current collector is coated with the negative-electrode composite material or the positive-electrode composite material, and is dried so as to form the negative-electrode composite layer or the positive-electrode composite layer.

(2) The area and the weight of each negative-electrode composite layer or each positive-electrode composite layer are measured, and the basis weight (=weight of the positive-electrode composite material or the negative-electrode composite material/area of the positive-electrode composite layer or the negative-electrode composite layer) is calculated.

It is preferable to perform the coating such that the density (g/cm³) of the negative-electrode active material or the positive-electrode active material in the negative-electrode composite layer or the positive-electrode composite layer of each of the electrodes located at upper positions in the stacking direction of the assembled battery become larger than the density (g/cm³) of the negative-electrode active material or the positive-electrode active material in the negative-electrode composite layer or the positive-electrode composite layer of each of the electrodes located at lower positions in the stacking direction of the assembled battery. With this configuration, the electrodes increase in capacity and the portions equivalent to the difference in internal resistance are reduced; therefore, the phenomenon can be easily reduced that as the electrodes located at lower positions in the stacking direction of the assembled battery, increase in capacity due to thinning by the load becomes greater, and thus variation in degree of deterioration of the electrodes is caused due to overcharging at the time of charging the assembled battery.

It is preferable to perform the coating such that the density (g/cm³) of the negative-electrode active material or the positive-electrode active material in the negative-electrode composite layer or the positive-electrode composite layer of the electrode located at the uppermost position of the assembled battery becomes 1 g/cm³ to 5 g/cm³, for example. It is preferable to perform the coating such that the density (g/cm³) of the negative-electrode active material or the positive-electrode active material in the negative-electrode composite layer or the positive-electrode composite layer of the electrode located at the lowermost position in the stacking direction of the assembled battery becomes 1 g/cm³ to 5 g/cm³, for example.

The coating may be performed such that when the thickness in the stacking direction of the assembled battery is 100 mm, for example, the density of the negative-electrode active material or the positive-electrode active material in the negative-electrode composite layer or the positive-electrode composite layer of the electrode located at the uppermost position of the assembled battery becomes 100.5% to 102%, or 101%, for example, of the density of the negative-electrode active material or the positive-electrode active material in the negative-electrode composite layer or the positive-electrode composite layer of the electrode located at the lowermost position in the stacking direction of the assembled battery.

The coating may be performed such that when the thickness in the stacking direction of the assembled battery is 200 mm, for example, the density of the negative-electrode active material or the positive-electrode active material in the negative-electrode composite layer or the positive-electrode composite layer of the electrode located at the uppermost position of the assembled battery becomes 101% to 104%, or 102%, for example, of the density of the negative-electrode active material or the positive-electrode active material in the negative-electrode composite layer or the positive-electrode composite layer of the electrode located at the lowermost position in the stacking direction of the assembled battery.

A density (g/cm³) can be found by dividing a basis weight (mg/cm²) by a thickness (cm) of a positive-electrode active material layer or a negative-electrode active material layer.

### Assembled Battery

The assembled battery of the present disclosure can be obtained by alternately stacking the electrodes and the electrolyte layers S.

### Electrolyte Layer S

Each electrolyte layer S may include a solid electrolyte layer or a separator.

When the electrolyte layer S is a solid electrolyte layer, as examples of the solid electrolyte, solid oxide electrolytes such as lithium lanthanum zirconate, LiPON, Li_{1+X}Al_{X}Ge_{2-X}(PO₄)₃, Li—SiO glass, and Li—Al—S—O glass; and sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂, etc., may be included. A solid electrolyte layer can be obtained by pressing the solid electrolyte.

When the electrolyte layer S includes a separator and an electrolyte, as examples of the separator, resin sheets of polyethylene (PE), polypropylene (PP), etc., may be included. The electrolyte includes a predetermined electrolyte and a solvent; and as examples of the predetermined electrolyte, LiPF₆, LiBF₄, LiAsF₆, Li(CF₃SO₂)₂N, Li(C₂F₅SO₂)₂N, LiTaF₆, LiClO₄, LiCF₃SO₃, etc., may be included.

As examples of the solvent, for example, cyclic carbonate solvents such as ethylene carbonate (EC) and propylene carbonate (PC); and chain carbonate solvents such as dimethyl carbonate (DMC), diethyl carbonate (DEC), and ethyl methyl carbonate (EMC), etc., may be included. The concentration of the electrolyte is 0.1 to 1 mol/L, for example.

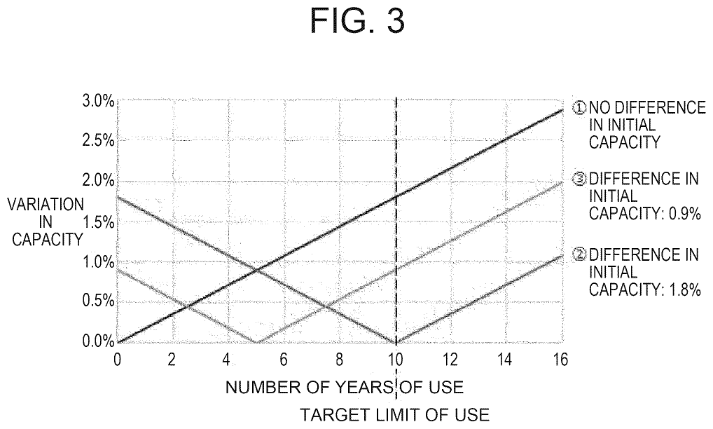

In the assembled battery of the present disclosure, when it is assumed that the thickness in the stacking direction of the assembled battery is 100 mm and the thickness in the stacking direction of each cell (single cell) is 0.5 mm, and after 10 years of use, the thickness of the positive electrode or the negative electrode of the cell (single cell) located at the uppermost position of the assembled battery is 1.018 times the thickness of the positive electrode or the negative electrode of the cell (single cell) located at the lowermost position of the assembled battery, as shown in FIG. 3, the difference in initial capacity (mAh/g) between the positive electrode or the negative electrode of the cell (single cell) located at the uppermost position of the assembled battery and the positive electrode or the negative electrode of the cell (single cell) located at the lowermost position of the assembled battery might be 1.8% in some cases. In this case, after 10 years of use, the difference in capacity (mAh/g) between the positive electrode or the negative electrode of the cell (single cell) located at the uppermost position of the assembled battery and the positive electrode or the negative electrode of the cell (single cell) located at the lowermost position of the assembled battery might be 0% in some cases.

In the assembled battery of the present disclosure, when it is assumed that the thickness in the stacking direction of the assembled battery is 100 mm, the thickness in the stacking direction of each cell (single cell) is 0.5 mm, and after 10 years of use, the thickness of the positive electrode or the negative electrode of the cell (single cell) located at the uppermost position of the assembled battery is 1.009 times the thickness of the positive electrode or the negative electrode of the cell (single cell) located at the lowermost position of the assembled battery, as shown in FIG. 3, the difference in initial capacity (mAh/g) between the positive electrode or the negative electrode of the cell (single cell) located at the uppermost position of the assembled battery and the positive electrode or the negative electrode of the cell (single cell) located at the lowermost position of the assembled battery might be 0.9% in some cases. In this case, after 5 years of use, the difference in capacity (mAh/g) between the positive electrode or the negative electrode of the cell (single cell) located at the uppermost position of the assembled battery and the positive electrode or the negative electrode of the cell (single cell) located at the lowermost position of the assembled battery might be 0% in some cases.

As for the above two examples, the former example is preferable, after 10 years of use, in light of reducing the difference in capacity (mAh/g) between the positive electrode or the negative electrode of the cell (single cell) located at the uppermost position of the assembled battery and the positive electrode or the negative electrode of the cell (single cell) located at the lowermost position of the assembled battery. In addition, the latter example is preferable, over a 10-year period of use, in light of reducing the difference in capacity (mAh/g) between the positive electrode or the negative electrode of the cell (single cell) located at the uppermost position of the assembled battery and the positive electrode or the negative electrode of the cell (single cell) located at the lowermost position of the assembled battery.

When it is assumed that no thinning of the electrodes due to the load is caused, the difference in initial capacitance (mAh/g) might be 0% in some cases, as shown in FIG. 3.

In the assembled battery of the present disclosure, when the weight per 1 m² is 3N, the difference in surface pressure between the uppermost portion and the lowermost portion of the assembled battery is 3 kPa. Due to this difference in surface pressure, the difference in internal resistance between the positive electrode or the negative electrode of the cell (single cell) located at the uppermost position of the assembled battery and the positive electrode or the negative electrode of the cell (single cell) located at the lowermost position of the assembled battery might be 1 μΩ in some cases. Due to this difference in surface pressure, the temperature difference between the positive electrode or the negative electrode of the cell (single cell) located at the uppermost position of the assembled battery and the positive electrode or the negative electrode of the cell (single cell) located at the lowermost position of the assembled battery might be 0.2° C. in some cases. Due to this difference in surface pressure, after 10 years of use, the difference in capacity (mAh/g) between the positive electrode or the negative electrode of the cell (single cell) located at the uppermost position of the assembled battery and the positive electrode or the negative electrode of the cell (single cell) located at the lowermost position of the assembled battery is calculated to be 1.8% from FIG. 2. In this case, the higher the temperature, the greater the tendency of decrease in capacity.

What is claimed is:

1. An assembled battery comprising a plurality of electrodes, each of the electrodes including: a current collector; a negative-electrode composite layer disposed on one surface of the current collector; and a positive-electrode composite layer on the other surface of the current collector, the electrodes being stacked alternately with an electrolyte layer interposed between the electrodes,
wherein a basis weight (mg/cm²) of a negative-electrode composite material or a positive-electrode composite material in the negative-electrode composite layer or the positive-electrode composite layer of each of the electrodes located at upper positions in a stacking direction of the assembled battery is larger than a basis weight (mg/cm²) of a negative-electrode composite material or a positive-electrode composite material in the negative-electrode composite layer or the positive-electrode composite layer of each of the electrodes located at lower positions in the stacking direction of the assembled battery.

2. The assembled battery according to claim 1, wherein a density (g/cm³) of a negative-electrode active material or a positive-electrode active material of the negative-electrode composite material or the positive-electrode composite material in the negative-electrode composite layer or the positive-electrode composite layer of each of the electrodes located at the upper positions in the stacking direction is larger than a density (g/cm³) of a negative-electrode active material or a positive-electrode active material of the negative-electrode composite material or the positive-electrode composite material in the negative-electrode composite layer or the positive-electrode composite layer of each of the electrodes located at the lower positions in the stacking direction.
